(19) United States
(12) Patent Application Publication
(10) Pub. No.: US 2015/0057785 A1
(43) Pub. Date: Feb. 26, 2015

(54) THREE-DIMENSIONAL PRINTING APPARATUS AND THREE-DIMENSIONAL PREVIEW AND PRINTING METHOD THEREOF

(71) Applicants: XYZprinting, Inc., New Taipei City (TW); Cal-Comp Electronics & Communications Company Limited, New Taipei City (TW); Kinpo Electronics, Inc., New Taipei City (TW)

(72) Inventors: Hua Liu, New Taipei City (TW); Hong-Chuan Yeh, New Taipei City (TW)

(73) Assignees: XYZprinting, Inc., New Taipei City (TW); Cal-Comp Electronics & Communications Company Limited, New Taipei City (TW); Kinpo Electronics, Inc., New Taipei City (TW)

(21) Appl. No.: 14/151,835

(22) Filed: Jan. 10, 2014

Related U.S. Application Data
(60) Provisional application No. 61/869,079, filed on Aug. 23, 2013.

(30) Foreign Application Priority Data
Nov. 8, 2013 (TW) 102140705

(51) Int. Cl. G06F 17/50; G05B 19/4099

(52) U.S. Cl. CPC G06F 17/50; G05B 19/4099; G05B 2219/31053; G05B 2219/31056
USPC 700/119

(57) ABSTRACT

A three-dimensional (3-D) printing apparatus includes a processing unit, a base, and a printing head. The processing unit is configured to read and process a first digital 3-D model and is adapted to receive an adjustment signal to adjust the first digital 3-D model to a second digital 3-D model according to the adjustment signal. The printing head is coupled to and controlled by the processing unit. If the second digital 3-D model is confirmed, the processing unit saves the second digital 3-D model and controls the printing head to dispense a construction material in a layer-by-layer manner on the base to form a 3-D object associated with the second digital 3-D model.

### CROSS-REFERENCE TO RELATED APPLICATION

This application claims the priority benefits of U.S. provisional application Ser. No. 61/869,079, filed on Aug. 23, 2013 and Taiwan application serial no. 102140705, filed on Nov. 8, 2013. The entirety of each of the above-mentioned patent applications is hereby incorporated by reference herein and made a part of this specification.

### BACKGROUND OF THE INVENTION

1. Field of the Invention

The invention relates to a printing apparatus and a preview and printing method thereof, and more particularly to a three-dimensional (3-D) printing apparatus and a preview and printing method thereof

2. Description of Related Art

Along with the progress in computer-aided manufacturing (CAM), manufacturers have developed the three-dimensional (3-D) printing technology to rapidly embody an original design concept. The 3-D printing technology is by meaning a collective term referring to a series of rapid prototyping (RP) techniques, and the basic principle is additive manufacturing, where a RP machine is used to form cross-sectional shapes of a workpiece in an X-Y plane through scanning, shift intermittently at a layer thickness in the Z coordinates, and ultimately form 3-D objects. The 3-D printing technology is applicable regardless of the geometric shapes, and the RP technology produces excellent outputs in particular for complex parts, which significantly saves efforts and processing time. The 3-D printing technology is capable of presenting an object of a digital 3-D model designed by means of computer-aided design (CAD) software in less time for a user to touch and actually feel the geometry of the model, or even to test the assembling ability of the parts and possible functions.

However, in an existing 3-D printing apparatus that produces 3-D objects through utilizing said RP technique, the 3-D printing process is directly performed right after the digital 3-D model manufactured by computer software is read. The resultant 3-D object can merely be discarded once it is below expectation, and the digital 3-D model need be revised for subsequent printing. As a result, the existing 3-D printing apparatus is inconvenient in terms of use and operation and is apt to waste the construction material, and the production costs may be raised.

### SUMMARY OF THE INVENTION

The invention is directed to a three-dimensional (3-D) printing apparatus and a 3-D preview and 3-D printing method, so as to preview a to-be-printed 3-D object in a 3-D manner to in advance examine or adjust printing effects of the 3-D object before the 3-D printing is actually performed.

In an embodiment of the invention, a 3-D printing apparatus includes a processing unit, a base, and a printing head. The processing unit is configured to read and process a first digital 3-D model. Besides, the processing unit is adapted to receive an adjustment signal to adjust the first digital 3-D model to a second digital 3-D model according to the adjustment signal. The base has a carrying surface. The printing head is located above the base, coupled to the processing unit, and controlled by the processing unit. If the second digital 3-D model is confirmed, the processing unit saves the second digital 3-D model and controls the printing head to dispense a construction material in a layer-by-layer manner on the carrying surface of the base to form a 3-D object associated with the second digital 3-D model.

In an embodiment of the invention, a 3-D preview and 3-D printing method includes following steps. A first digital 3-D model is read. After receiving an adjustment signal, the first digital 3-D model is adjusted to a second digital 3-D model according to the adjustment signal. If the second digital 3-D model is confirmed, a 3-D object associated with the second digital 3-D model is printed.

In view of the above, the 3-D printing apparatus allows a user to utilizing the processing unit of the 3-D printing apparatus to read and process a digital 3-D model after the digital 3-D model is built by the user, and the digital 3-D model may be repeatedly adjusted to meet the requirement of the user. After the user confirms the printing action, the processing unit controls the printing head to dispense the construction material in the layer-by-layer manner on the base, so as to form the 3-D object associated with the adjusted digital 3-D model. Thereby, it is likely to print the 3-D object that satisfies the user's preferences and requirements without wasting the construction material. As a result, the 3-D printing apparatus is characterized by convenience and utility in terms of use and operation, the waste of the construction material may be prevented, and the production costs may be reduced.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating an operating environment of a 3-D printing apparatus according to an embodiment of the invention.

FIG. 2A and FIG. 2B are schematic block diagrams illustrating a portion of a 3-D printing apparatus according to an embodiment of the invention.

FIG. 3 is a schematic diagram illustrating some components of a 3-D printing apparatus according to an embodiment of the invention.

FIG. 4 is a schematic diagram illustrating scenarios of employing some components of a 3-D printing apparatus according to an embodiment of the invention.

FIG. 5 is a schematic diagram illustrating a relationship between a first 3-D image and a real object according to an embodiment of the invention.

FIG. 6 is a schematic diagram illustrating a relationship among a second 3-D image, a real object, and a 3-D object according to an embodiment of the invention.

FIG. 7 is a schematic block diagram illustrating a 3-D preview and 3-D printing method according to an embodiment of the invention.

### DETAILED DESCRIPTION OF DISCLOSED EMBODIMENTS

It is to be understood that the foregoing and other detailed descriptions, features, and effects are intended to be described more comprehensively by providing embodiments accompanied with figures hereinafter. In the following embodiments, wording used to indicate directions, such as “up,” “down,” “front,” “back,” “left,” and “right,” merely refers to directions in the accompanying drawings. Therefore, the directional wording is used to illustrate rather than limit the invention. Moreover, the same or similar reference numerals represent the same or similar elements in the following embodiments.

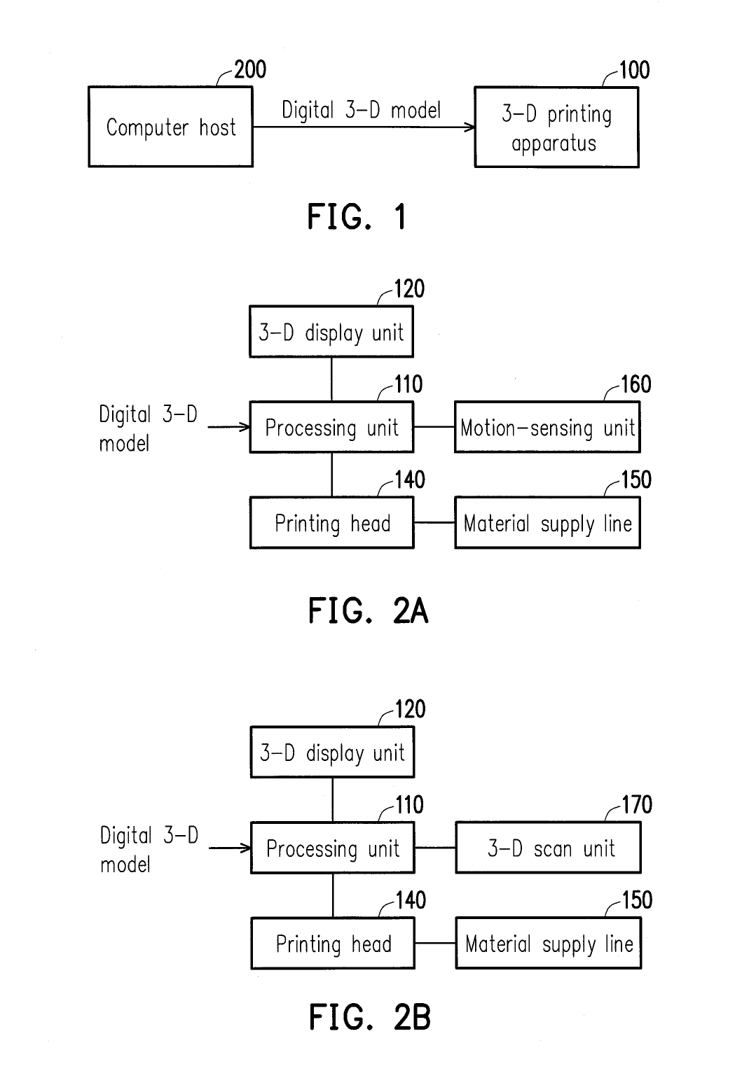

FIG. 1 is a schematic diagram illustrating an operating environment of a 3-D printing apparatus according to an embodiment of the invention. FIG. 2A and FIG. 2B are schematic block diagrams illustrating a 3-D printing apparatus according to an embodiment of the invention. FIG. 3 is a schematic diagram illustrating some components of a 3-D printing apparatus according to an embodiment of the invention. With reference to FIG. 1 and FIG. 3, in the present embodiment, the 3-D printing apparatus 100 includes a processing unit 110, a base 130, and a printing head 140. The processing unit 110 is coupled to and controls the printing head 140. In the present embodiment, the processing unit 110 may serve to read a digital 3-D model; here, the digital 3-D model may be a digital 3-D image file built by a computer host 200 by means of computer-aided design (CAD) or animation modeling software, for instance. The 3-D printing apparatus 100 is adapted to print a 3-D object 10 according to the digital 3-D model.

Further to the above, the base 130 has a carrying surface 132 for supporting a build material provided by the printing head 140. The printing head 140 is located above the base 130 and is controlled by the processing unit 110 to dispense construction material in a layer-by-layer manner on the carrying surface 132, so as to form a plurality of construction material layers. The construction material layers are stacked on top of each other to form the 3-D object 10. According to the present embodiment, the construction material dispensed by the printing head 140 by layers on the carrying surface 132 may include a building material, a support material that supports the building material, and a release material located between the building material and the support material. In particular, the construction material dispensed on the carrying surface 132 not only includes the building material of the 3-D object 10 but also includes the support material that supports the 3-D object and the release material located between the building material and the support material. After the construction material dispensed on the carrying surface 132 is cured, the support material and the release material may then be removed, so as to obtain the 3-D object 10.

In the present embodiment, the 3-D printing apparatus 100 may further include at least one material supply line 150 that is coupled to the printing head 140. The material supply line 150 may be a solid spool composed of thermal-melting construction material. The solid spool may be heated by a heating unit, such that the construction material in a melted state is squeezed from the printing head 140 and stacked onto the carrying surface 132 layer by layer, so as to form a plurality of construction material layers. The construction material layers are then cured and dried to form the 3-D object 10. In another embodiment of the invention, the material supply line 150 may also be a pipe that carries and transmits the fluid or gel-like construction material to the printing head 140. After that, the fluid or gel-like construction material is squeezed from the printing head 140 and shaped on the carrying surface 132, and then the construction material is cured and dried to form the 3-D object 10.

In the present embodiment, the processing unit 110 is configured to read and process a first digital 3-D model. If the first digital 3-D model is confirmed, the processing unit 110 controls the printing head 140 to dispense the construction material in the layer-by-layer manner on the carrying surface 132 to form the 3-D object 10 associated with the first digital 3-D model. However, if the user intends to adjust the first digital 3-D model, an adjustment signal may be issued through a medium and may then be received by the processing unit 110, such that the processing unit 110 adjusts the first digital 3-D model to a second digital 3-D model according to the adjustment signal. If the adjusted second digital 3-D model is confirmed by the user, the processing unit 110 saves the second digital 3-D model and controls the printing head 140 to dispense the construction material in the layer-by-layer manner on the carrying surface 132 to form the 3-D object 10 associated with the second digital 3-D model. Note that the first digital 3-D model described herein may be constructed by a computer host 200 by means of CAD or animation modeling software, for instance. The processing unit 110 reads the initial first digital 3-D model to control the 3-D display unit 120 to display a first 3-D image 20 associated with the initial first digital 3-D model for preview and confirmation or adjustment. However, in another embodiment of the invention, the first digital 3-D model may also be any adjusted digital 3-D model rather than the initial digital 3-D model constructed by the computer host 200. Certainly, the number of preview and confirmation or adjustment is not limited in the invention, and the processing unit 110 is capable of controlling the printing head 140 to dispense the construction material in the layer-by-layer manner on the carrying surface 132 to form the 3-D object 10 associated with the second digital 3-D model after multiple times of adjustments and confirmations.

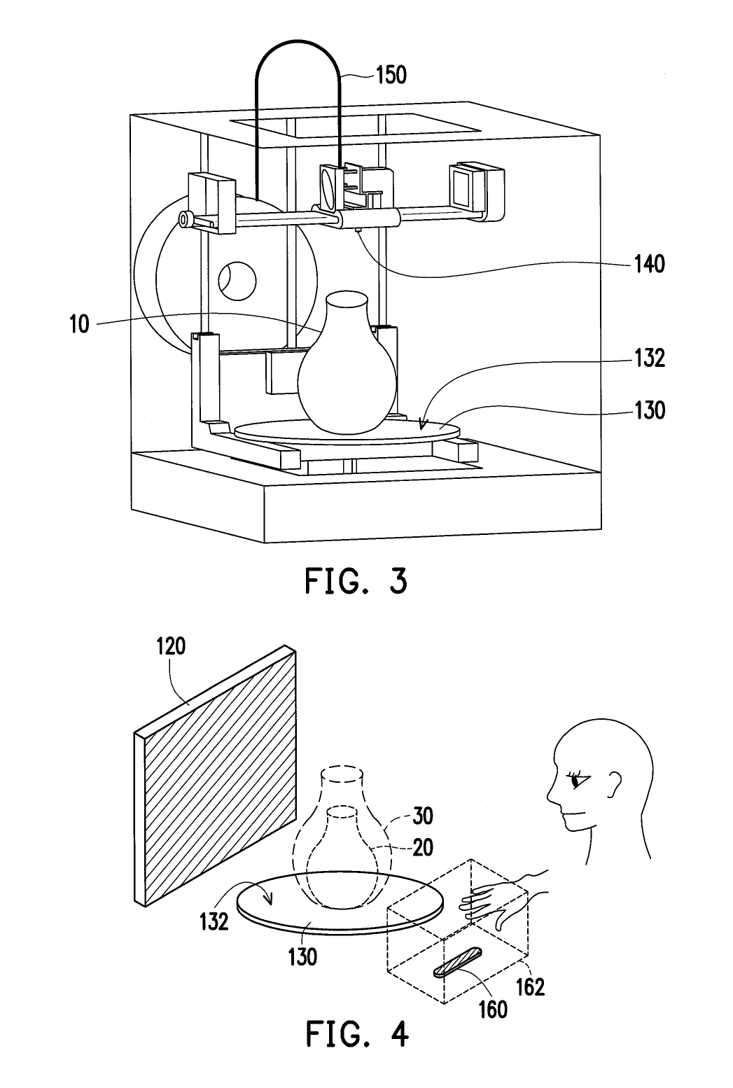

FIG. 4 is a schematic diagram illustrating scenarios of employing some components of a 3-D printing apparatus according to an embodiment of the invention. With reference to FIG. 2 to FIG. 4, in the present embodiment, the 3-D printing apparatus may further include a 3-D display unit 120 that is coupled to and controlled by the processing unit 110, so as to display the first 3-D image 20 that is associated with the first digital 3-D model for a user's preview and confirmation or making further adjustment. If the first 3-D image 20 is previewed and confirmed by the user, the processing unit 110 controls the printing head 140 to dispense the construction material in the layer-by-layer manner on the carrying surface 132 to form the 3-D object 10 associated with the first digital 3-D model. However, if the user intends to adjust the first digital 3-D model after preview, an adjustment signal may be issued through a medium and may then be received by the processing unit 110, such that the processing unit 110 adjusts the first digital 3-D model to the second digital 3-D model according to the adjustment signal and controls the 3-D display unit 120 to display a second 3-D image 30 associated with the second digital 3-D model for the user's preview and confirmation or adjustment. If the second 3-D image 30 is previewed and confirmed by the user, the processing unit 110 controls the printing head 140 to dispense the construction material in the layer-by-layer manner on the carrying surface 132 to form the 3-D object 10 associated with the second digital 3-D model. Note that the first digital 3-D model described herein may be constructed by a computer host 200 by means of CAD or animation modeling software, for instance. The processing unit 110 reads the initial first digital 3-D model to control the 3-D display unit 120 to display a first 3-D image 20 associated with the initial first digital 3-D model for preview and confirmation or adjustment. However, in another embodiment of the invention, the first digital 3-D model may also be any adjusted digital 3-D model rather than the initial digital 3-D model constructed by the computer host 200. Certainly, the number of times for previewing and confirmation or adjustment is not limited in the invention, and the processing unit 110 is capable of controlling the printing head 140 to dispense the construction material in the layer-by-layer manner on the carrying surface 132 to form the 3-D object 10 associated with the second digital 3-D model after multiple times of adjustments and confirmations.

The aforesaid medium is, for instance, a motion-sensing unit 160 of the 3-D printing apparatus 100 coupled to the processing unit 100 for detecting a body motion of a user in a motion-sensing region 162 and generating the adjustment signal according to the detected body motion. Thereby, the processing unit 110 is able to adjust the digital 3-D model according to the adjustment signal. Specifically, the motion-sensing unit 160 may generate the adjustment signal through detecting variations in hand gestures of the user. The processing unit 110 may adjust, for instance, a dimension of the first digital 3-D model according to the adjustment signal, so as to generate the second digital 3-D model whose dimension is different from that of the first digital 3-D model. The processing unit 110 then controls the 3-D display unit 120 to display the second 3-D image 30 associated with the second digital 3-D model for the user's preview and confirmation or adjustment. That is, through previewing the 3-D image associated with the digital 3-D model, the user is able to adjust the dimension of the digital 3-D model by means of variations in gestures, for instance. Certainly, the user is also able to input desired characteristic parameters (e.g., color, shape, and so forth) of the to-be-adjusted digital 3-D model through an input interface for the processing unit 110 to read the desired characteristic parameters and adjust the digital 3-D model accordingly. Those with ordinary skills in the art should understand that the present embodiment and the accompanying drawings are merely exemplary, while the method and the manner of adjusting the digital 3-D model are not limited in the invention.

In addition, the 3-D image may be displayed at a predetermined location where the 3-D object 10 is to be formed on the carrying surface 132, such that the user is able to virtually preview the printing effects of the digital 3-D model. Specifically, after the processing unit 110 reads the digital 3-D model, the spatial data of the digital 3-D model may be converted into corresponding X-Y-Z coordinates on the carrying surface 132, and a predetermined location where the 3-D object 10 is to be formed on the carrying surface 132 is set. The processing unit 110 then controls the 3-D display unit 120 to display the 3-D image associated with the digital 3-D model at the predetermined location, such that the user is able to sense the printing effects of the digital 3-D model on the carrying surface 132.

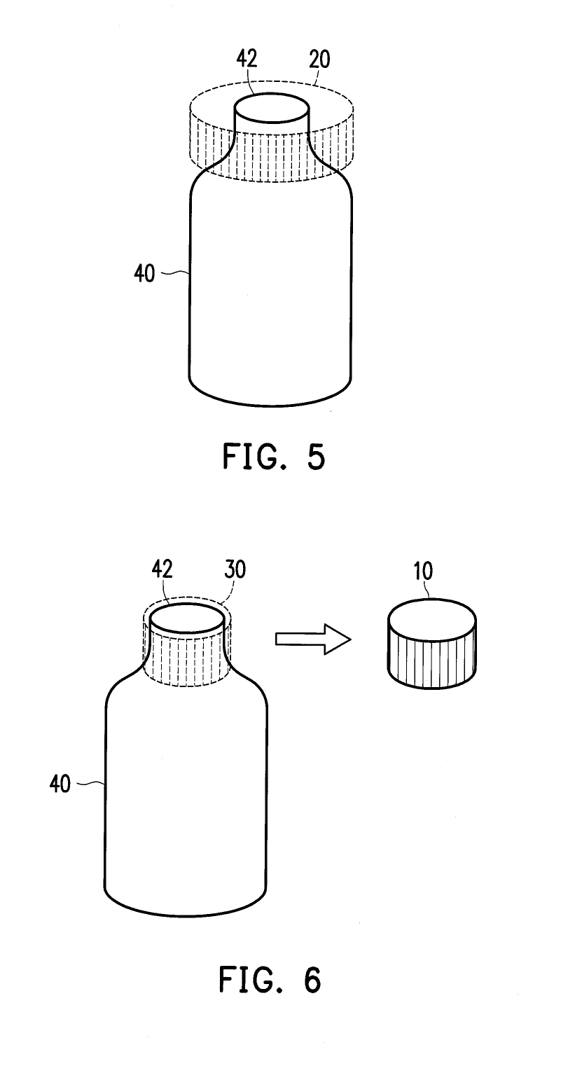

FIG. 5 is a schematic diagram illustrating a relationship between a first 3-D image and a real object according to an embodiment of the invention. FIG. 6 is a schematic diagram illustrating a relationship among a second 3-D image, a real object, and a 3-D object according to an embodiment of the invention. With reference to FIG. 5 and FIG. 6, in the present embodiment, the 3-D printing apparatus 100 is able to print the 3-D object according to a 3-D real object. For instance, the 3-D real object is a water bottle 40 having an opening 42, and the user intends to print a lid that matches the opening 42. Here, the user firstly builds a first digital 3-D model of the lid by means of the computer host 200. The processing unit 110 reads the first digital 3-D model and controls the 3-D display unit 120 to display the first 3-D image 20 associated with the first digital 3-D model, i.e., the first 3-D image of the lid. In the present embodiment, the user may place the water bottle 40 onto the base 130, for instance, and the processing unit 110 is able to control the 3-D display unit 120 to display the 3-D image of the lid at the place where the opening 42 of the water bottle 40 is located. Thereby, the user is able to sense the printing effects of the first digital 3-D model and determine whether the first digital 3-D model should be adjusted according to the shape of the opening 42 and the matching relationship between the opening 42 and the first 3-D image 20 of the lid. At this time, if the first 3-D image 20 of the lid is previewed and confirmed by the user, the processing unit 110 controls the printing head 140 to dispense the construction material in the layer-by-layer manner on the carrying surface 132 to form the 3-D lid 10 associated with the first digital 3-D model.

If the user, after preview, intends to adjust the first 3-D image 20 of the lid by, for instance, reducing the dimension of the first 3-D image 20 of the lid an adjustment signal may be generated by the motion-sensing unit 160 or any other input medium. The motion-sensing unit 160 may detect the body motion of the user in the motion-sensing region 162 and thereby generate the adjustment signal according to the detected body motion, such that the processing unit 110 is able to adjust the digital 3-D model according to the adjustment signal. Particularly, the motion-sensing unit 160 may generate the adjustment signal through detecting the gestures of the user, for instance. At this time, the processing unit 110 receives the adjustment signal and accordingly adjusts the first digital 3-D model to the second digital 3-D model whose dimension is smaller than that of the first digital 3-D model. Besides, the processing unit 110 controls the 3-D display unit 120 to display the second 3-D image (i.e., the second 3-D image 30 with the small dimension, as shown in FIG. 6) associated with the second digital 3-D model for the user's preview and confirmation or further adjustment. If the second 3-D image 30 of the lid is previewed and confirmed by the user, the processing unit 110 controls the printing head 140 to dispense the construction material in the layer-by-layer manner on the carrying surface 132 to form the 3-D object 10 (i.e., the lid structurally matching the opening 42 as shown in FIG. 6) associated with the second digital 3-D model. Based on the real object, the user is able to print the 3-D object 10 matching the real object by means of the 3-D printing apparatus 100, and thus the utility of the 3-D printing apparatus may be enhanced.

In another embodiment of the invention, the processing unit 110 may be further coupled to a 3-D scan unit 170, for instance. The 3-D scan unit 170 is configured to scan a 3-D real object and thereby generate digital 3-D real object information 40 associated with the 3-D real object. In the present embodiment, the digital 3-D real object information 40 is the adjustment signal. For instance, the 3-D real object is a water bottle having an opening, and the user intends to print a lid that matches the opening. The user may firstly perform 3-D scanning on the water bottom through the 3-D scan unit 170, so as to generate the digital 3-D real object information 40 associated with the water bottle. Herein, the digital 3-D real object information 40 is the digital 3-D scan file of the water bottle. The user may, for instance, build the first digital 3-D model of the lid by means of the computer host 200, such that the processing unit 110 is able to read the first digital 3-D model. The user may then adjust the first digital 3-D model to the second digital 3-D model according to the digital 3-D real object information 40. In particular, the user may, by utilizing the modeling software, match the first digital 3-D model associated with the lid with the digital 3-D real object information 40 associated with the opening of the water bottle; according to the engagement of the opening 42 and the lid, whether the first digital 3-D model requires further adjustment or not can be determined. At this time, if the first digital 3-D model associated with the lid is confirmed, the processing unit 110 controls the printing head 140 to dispense the construction material in the layer-by-layer manner on the carrying surface 132 to form the 3-D lid 10 associated with the first digital 3-D model.

If the user intends to adjust the first digital 3-D model associated with the lid, the user may, by means of the modeling software or any other appropriate computer software, adjust the first digital 3-D model to the second digital 3-D model (whose dimension is smaller than that of the first digital 3-D model) according to the engagement of the opening 42 associated with the digital 3-D real object information 40 and the lid associated with the first digital 3-D model. Here, if the second digital 3-D model is confirmed, the processing unit 110 saves the second digital 3-D model and controls the printing head 140 to dispense the construction material in the layer-by-layer manner on the carrying surface 132 to form the 3-D object 10 (i.e., the lid structurally matching the opening 42 as shown in FIG. 6) associated with the second digital 3-D model. Based on the real object, the user is able to print the 3-D object 10 matching the real object by means of the 3-D printing apparatus 100, and thus the utility of the 3-D printing apparatus may be enhanced.

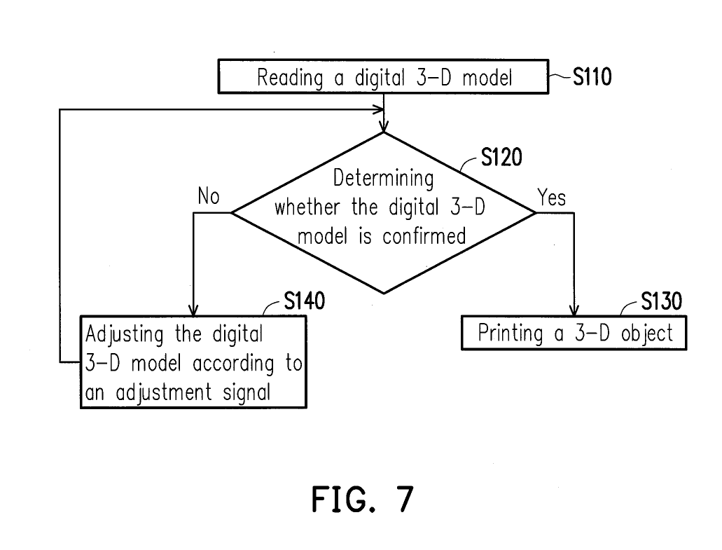

FIG. 7 is a schematic block diagram illustrating a 3-D preview and 3-D printing method according to an embodiment of the invention. The 3-D preview and 3-D printing method derived from the above descriptions is applicable to the 3-D printing apparatus 100. With reference to FIG. 7, the 3-D preview and 3-D printing method includes following steps. In step S110, a digital 3-D model is read. In the present embodiment, the first digital 3-D model may be the initial digital 3-D model established by the computer host, and the processing unit 110 of the 3-D printing apparatus 100 is adapted for reading and processing the first digital 3-D model. Certainly, the invention is not limited thereto; in another embodiment of the invention, the first digital 3-D model may also be any adjusted digital 3-D model rather than the initial digital 3-D model constructed by the computer host. In an embodiment of the invention, the 3-D printing apparatus 100 may further include a 3-D display unit 120 that displays the first 3-D image associated with the first digital 3-D model for a user's preview and confirmation or adjustment. In step S120, it is determined whether or not the digital 3-D model is confirmed. Particularly, the user may issue the adjustment signal or the confirmation signal through a medium, so as to adjust or confirm the first digital 3-D model. The medium may be an input interface or the motion-sensing unit 160. In an embodiment of the invention, after the 3-D display unit 120 displays the first 3-D image, the motion-sensing unit 160 may detect the body motion of the user in a motion-sensing region and then generate the adjustment signal or the confirmation signal according to the detected body motion. The medium may also be modeling software, and the user may obtain digital 3-D real object information through scanning a 3-D real object and adjust the first digital 3-D model through the modeling software according to the digital 3-D real object information. The 3-D printing apparatus may receive the adjustment signal or the confirmation signal through its processing unit.

If the first digital 3-D model is confirmed, in step S130, the 3-D object is printed. Specifically, if the first digital 3-D model is previewed and confirmed by the user, and the user issues the confirmation signal through the medium, the 3-D object associated with the first digital 3-D model is printed.

In an embodiment of the invention, if the user does not confirm the first digital 3-D model but issues the adjustment signal through the medium, the 3-D printing apparatus adjusts the digital 3-D model according to the adjustment signal in step S140. Specifically, after receiving the adjustment signal, the processing unit adjusts the first digital 3-D model to the second digital 3-D model according to the adjustment signal. For instance, the processing unit may adjust a dimension of the first digital 3-D model according to the adjustment signal to generate the second digital 3-D model whose dimension is different from that of the first digital 3-D model. Next, in an embodiment of the invention, the display unit 120 may display the second 3-D image associated with the second digital 3-D model for the user's preview and confirmation or adjustment. After the user's preview, the user may again issue the adjustment signal or the confirmation signal to the 3-D printing apparatus through the medium, i.e., the step S130 is again performed.

If the second digital 3-D model is confirmed, in step S130, the 3-D object is printed. That is, the 3-D object associated with the second digital 3-D model is printed. If the user does not preview and confirm the second digital 3-D model but again issues the adjustment signal through said medium, the 3-D printing apparatus may again perform the step S140. The adjustments continue until the confirmation signal is received, and the 3-D object associated with the previewed and confirmed digital 3-D model is printed according to the previewed and confirmed digital 3-D model.

To sum up, in the 3-D printing apparatus described herein, the processing unit is coupled to and controls the 3-D display unit and the printing head, such that the printing unit is able to read and process the digital 3-D model after the digital 3-D model is built by the user; the digital 3-D model may be repeatedly adjusted to meet the expectation of the user. After the user confirms the printing action, the processing unit controls the printing head to dispense the construction material in the layer-by-layer manner on the base, so as to form the 3-D object associated with the adjusted digital 3-D model. Thereby, it is likely to print the 3-D object that satisfies the user's preference and requirement and prevent the waste of the construction material. Moreover, the 3-D printing apparatus is able to print the 3-D object that matches a real object according to the real object. That is, based on the relationship between the real object and the 3-D image, the user is able to adjust the digital 3-D model, so as to print the 3-D object matching the real object. As a result, the 3-D printing apparatus is characterized by convenience and utility in terms of use and operation, the use of the construction material may be economized, and the production costs may be reduced.

Although the invention has been described with reference to the above exemplary embodiments, it will be apparent to one of ordinary skill in the art that modifications to the described exemplary embodiments may be made without departing from the spirit of the invention. Accordingly, the scope of the invention will be defined by the attached claims and not by the above detailed descriptions.

What is claimed is:

1. A three-dimensional printing apparatus comprising:
a processing unit configured to read and process a first digital three-dimensional model and adapted to receive an adjustment signal to adjust the first digital three-dimensional model to a second digital three-dimensional model according to the adjustment signal;
a base having a carrying surface; and
a printing head located above the base, coupled to the processing unit, and controlled by the processing unit, wherein if the second digital three-dimensional model is confirmed, the processing unit saves the second digital three-dimensional model and controls the printing head to dispense a construction material in a layer-by-layer manner on the carrying surface of the base to form a three-dimensional object associated with the second digital three-dimensional model.

2. The three-dimensional printing apparatus as claimed in claim 1, further comprising a three-dimensional display unit coupled to and controlled by the processing unit, the processing unit controlling the three-dimensional display unit to display a first three-dimensional image associated with the first digital three-dimensional model.

3. The three-dimensional printing apparatus as claimed in claim 2, wherein if the first three-dimensional image associated with the first digital three-dimensional model is previewed and confirmed, the processing unit controls the printing head to dispense the construction material in the layer-by-layer manner on the carrying surface of the base to form the three-dimensional object associated with the first digital three-dimensional model.

4. The three-dimensional printing apparatus as claimed in claim 2, wherein if the processing unit adjusts the first digital three-dimensional model to the second digital three-dimensional model according to the adjustment signal, the processing unit controls the three-dimensional display unit to display a second three-dimensional image associated with the second digital three-dimensional model for preview and confirmation or adjustment.

5. The three-dimensional printing apparatus as claimed in claim 4, wherein if the second three-dimensional image associated with the second digital three-dimensional model is previewed and confirmed, the processing unit controls the printing head to dispense the construction material in the layer-by-layer manner on the carrying surface of the base to form the three-dimensional object associated with the second digital three-dimensional model.

6. The three-dimensional printing apparatus as claimed in claim 1, further comprising a motion-sensing unit coupled to the processing unit to detect a body motion in a motion-sensing region and generate the adjustment signal according to the detected body motion.

7. The three-dimensional printing apparatus as claimed in claim 1, wherein the processing unit adjusts a dimension of the first digital three-dimensional model according to the adjustment signal to generate the second digital three-dimensional model.

8. The three-dimensional printing apparatus as claimed in claim 1, wherein the adjustment signal is digital three-dimensional real object information associated with a three-dimensional real object, and the processing unit is configured to read and process the digital three-dimensional real object information and adjust the first digital three-dimensional model to the second digital three-dimensional model according to the digital three-dimensional real object information.

9. The three-dimensional printing apparatus as claimed in claim 8, wherein the digital three-dimensional real object information is a digital three-dimensional scan file of the three-dimensional real object.

10. The three-dimensional printing apparatus as claimed in claim 8, wherein the processing unit adjusts a dimension of the first digital three-dimensional model according to the digital three-dimensional real object information to generate the second digital three-dimensional model.

11. The three-dimensional printing apparatus as claimed in claim 8, wherein the three-dimensional object and the three-dimensional real object are structurally matched.

12. A three-dimensional preview and three-dimensional printing method comprising:
reading a first digital three-dimensional model;
when receiving an adjustment signal, adjusting the first digital three-dimensional model to a second digital three-dimensional model according to the adjustment signal; and
if the second digital three-dimensional model is confirmed, saving the second digital three-dimensional model and printing a three-dimensional object associated with the second digital three-dimensional model.

13. The three-dimensional preview and three-dimensional printing method as claimed in claim 12, further comprising:
displaying a first three-dimensional image associated with the first digital three-dimensional model for preview and confirmation or adjustment;
if the first three-dimensional image is previewed and confirmed, printing the three-dimensional object associated with the first digital three-dimensional model.

14. The three-dimensional preview and three-dimensional printing method as claimed in claim 12, further comprising:
after adjusting the first digital three-dimensional model to the second digital three-dimensional model according to the adjustment signal, displaying a second three-dimensional image associated with the second digital three-dimensional model for preview and confirmation or adjustment.

15. The three-dimensional preview and three-dimensional printing method as claimed in claim 12, further comprising:
detecting a body motion in a motion-sensing region and generating the adjustment signal according to the detected body motion.

16. The three-dimensional printing apparatus as claimed in claim 12, wherein the step of adjusting the first digital three-dimensional model to the second digital three-dimensional model according to the adjustment signal further comprises:
adjusting a dimension of the first digital three-dimensional model according to the adjustment signal to generate the second digital three-dimensional model.

17. The three-dimensional preview and three-dimensional printing method as claimed in claim 12, further comprising:
scanning a three-dimensional real object to generate the adjustment signal, wherein the adjustment signal is digital three-dimensional real object information associated with the three-dimensional real object;
adjusting the first digital three-dimensional model to the second digital three-dimensional model according to the adjustment signal.
